(19) United States
(12) Patent Application Publication
(10) Pub. No.: US 2020/0328704 A1
(43) Pub. Date: Oct. 15, 2020

(54) LOAD CONTROL DEVICE, LOAD CONTROL SYSTEM AND IN-VEHICLE CONTROL SYSTEM

(71) Applicant: YAZAKI CORPORATION, Tokyo (JP)

(72) Inventor: Koji Ikegaya, Makinohara-shi (JP)

(21) Appl. No.: 16/813,642

(22) Filed: Mar. 9, 2020

(30) Foreign Application Priority Data
Apr. 11, 2019 (JP) 2019-075605

(51) Int. Cl. H02P 7/03; H02P 5/68

(52) U.S. Cl. CPC H02P 7/04; H02P 7/05; H02P 5/68

(57) ABSTRACT

A load control device includes: one H-bridge circuit; half-bridge circuits; a common connection circuit that connects one terminal of each of the plurality of loads commonly to one output terminal of the H-bridge circuit; individual connection circuits, each of which connects the other terminal of each of the plurality of loads to the other output terminal of the H-bridge circuit or any one of the output terminals of the plurality of half-bridge circuits; and an exclusive control unit that generates signals to be respectively supplied to the H-bridge circuit and the plurality of half-bridge circuits to exclusively control the plurality of loads.

### CROSS REFERENCE TO RELATED APPLICATIONS

This application is based on and claims priority from Japanese patent application No. 2019-075605 filed on Apr. 11, 2019, the entire contents of which are incorporated herein by reference.

### BACKGROUND OF THE INVENTION

### 1. Technical Field

The present invention relates to a load control device, a load control system and an in-vehicle control system.

### 2. Background Art

Many different loads such as electric motors are mounted on a vehicle. Such a load can be reversibly driven by switching an energization direction. Therefore, in a circuit that drives this type of load, not only ON and OFF control of energization but also switching of the energization direction is required as necessary.

For example, a motor forward rotation and reverse rotation drive circuit in Patent Literature JP-A-2004-274817 includes an H-bridge circuit that drives a motor M to rotate forward and reversely. That is, among four transistors constituting the H-bridge circuit, the first and fourth two transistors MOS1 and MOS4 in a diagonal relationship are turned ON, and the remaining two transistors MOS2 and MOS3 are turned OFF, whereby the motor M as a load can be driven to rotate forward by allowing a current to flow in a specific direction. In addition, the second and third transistors MOS2 and MOS3 are turned ON, and the remaining two transistors MOS1 and MOS4 are turned OFF, whereby the motor M as the load can be driven to rotate reversely by allowing a current to flow in an opposite direction.

### SUMMARY

When the H-bridge circuit is used as in Patent Literature JP-A-2004-274817, four semiconductor devices are required to drive loads respectively. Moreover, when a large current flows through the load, a large and expensive semiconductor device is required.

For example, vicinity of a door on a vehicle are often provided with a motor that controls lock and unlock of a door lock mechanism, a motor that controls storage and expansion of a door mirror, and a plurality of motors that adjust a mirror surface direction of the door mirror in upper-lower and left-right directions. Such mechanisms exist for each of left and right doors. In this way, when the number of loads as control targets increases, the number of semiconductor devices required to drive the control targets is also enormous, which may result in an increase in cost.

The present invention has been made in view of the above circumstances, and an object thereof is to provide a load control device, a load control system and an in-vehicle control system capable of reducing the number of semiconductor devices and the like used for energization control when the number of loads as control targets is large.

In order to achieve the above object, the load control device, the load control system and the in-vehicle control system according to the present invention are characterized by the following (1) to (5).

(1) A load control device configured to control three or more independent loads that can be driven reversibly by switching an energization direction and that allow an alternative operation,

the load control device including:

one H-bridge circuit;

a plurality of half-bridge circuits;

a common connection circuit that connects one terminal of each of the plurality of loads commonly to one output terminal of the H-bridge circuit;

individual connection circuits, each of which connects the other terminal of each of the plurality of loads to the other output terminal of the H-bridge circuit or any one of the output terminals of the plurality of half-bridge circuits; and

an exclusive control unit that generates signals to be respectively supplied to the H-bridge circuit and the plurality of half-bridge circuits to exclusively control the plurality of loads.

(2) In the load control device according to (1),

when an input of a simultaneous drive instruction for each of the plurality of loads is detected, the exclusive control unit drives only the load having a highest priority among the plurality of loads for which the drive instruction has been generated, according to priorities assigned to the plurality of loads.

(3) A load control system includes:

three or more independent loads that can be reversibly driven by switching an energization direction and that allow an alternative operation;

one H-bridge circuit;

a plurality of half-bridge circuits;

a common connection circuit that connects one terminal of each of the plurality of loads commonly to one output terminal of the H-bridge circuit;

individual connection circuits, each of which connects the other terminal of each of the plurality of loads to the other output terminal of the H-bridge circuit or any one of the output terminals of the plurality of half-bridge circuits;

an exclusive control unit that generates signals to be respectively supplied to the H-bridge circuit and the plurality of half-bridge circuits to exclusively control the plurality of loads; and

a drive instruction generation unit that supplies a drive instruction for each of the plurality of loads to the exclusive control unit.

(4) In the load control system according to (3),

when the drive instruction for each of the plurality of loads is input from the drive instruction generation unit, the exclusive control unit drives only the load having a highest priority among the plurality of loads for which the drive instruction has been generated, according to priorities assigned to the plurality of loads.

(5) An in-vehicle control system includes:

three or more independent loads that are mounted on a vehicle and can be driven reversibly by switching an energization direction and that allow an alternative operation;

one H-bridge circuit;

a plurality of half-bridge circuits;

a common connection circuit that connects one terminal of each of the plurality of loads commonly to one output terminal of the H-bridge circuit;

individual connection circuits, each of which connects the other terminal of each of the plurality of loads to the other output terminal of the H-bridge circuit or any one of the output terminals of the plurality of half-bridge circuits;

an exclusive control unit that generates signals to be respectively supplied to the H-bridge circuit and the plurality of half-bridge circuits to exclusively control the plurality of loads; and

a drive instruction generation unit that supplies a drive instruction for each of the plurality of loads to the exclusive control unit.

According to the load control device having the configuration (1), energization control can be performed on the plurality of loads without using a plurality of H-bridge circuits. That is, a part of the single H-bridge circuit is commonly used by the plurality of loads, whereby the half-bridge circuits can be used instead of the H-bridge circuit. Since only two switch devices are needed to construct the half-bridge circuit for the energization control, the number of components can be significantly reduced as compared with that of the H-bridge circuit. In addition, since the exclusive control unit exclusively controls the plurality of loads, a malfunction due to influence of the common connection circuit can be avoided.

According to the load control device having the configuration (2), when the drive instruction for a second load having a high priority is generated at a later timing in a state in which a first load having a low priority is being driven, driving of the first load can be stopped and driving of the second load can be started. Therefore, a start of the driving of the load having the high priority can be prevented from being delayed.

According to the load control system having the configuration (3), energization control can be performed on the plurality of loads without using a plurality of H-bridge circuits. That is, a part of the single H-bridge circuit is commonly used by the plurality of loads, whereby the half-bridge circuits can be used instead of the H-bridge circuit. Since only two switch devices are needed to construct the half-bridge circuit for the energization control, the number of components can be significantly reduced as compared with that of the H-bridge circuit. In addition, since the exclusive control unit exclusively controls the plurality of loads, a malfunction due to influence of the common connection circuit can be avoided.

According to the load control system having the configuration (4), when the drive instruction for a second load having a high priority is generated at a later timing in a state in which a first load having a low priority is being driven, driving of the first load can be stopped and driving of the second load can be started. Therefore, a start of the driving of the load having the high priority can be prevented from being delayed.

According to the in-vehicle control system having the configuration (5), energization control can be performed on the plurality of loads without using a plurality of H-bridge circuits. That is, a part of the single H-bridge circuit is commonly used by the plurality of loads, whereby the half-bridge circuits can be used instead of the H-bridge circuit. Since only two switch devices are needed to construct the half-bridge circuit for the energization control, the number of components can be significantly reduced as compared with that of the H-bridge circuit. In addition, since the exclusive control unit exclusively controls the plurality of loads, a malfunction due to influence of the common connection circuit can be avoided. For example, the loads such as electric motors that respectively drive a door lock mechanism, a door mirror storage and expansion mechanism, and mirror surface angle adjustment mechanism of a door mirror in a vehicle are not necessarily required to be driven simultaneously. Therefore, when these loads are controlled, a part of the single H-bridge circuit is commonly used by the plurality of loads, whereby the total number of components can be reduced, and device cost and device weight can be reduced.

According to the load control device, the load control system and the in-vehicle control system of the present invention, a part of the single H-bridge circuit is commonly used by a plurality of loads, whereby the total number of the components can be reduced. Therefore, when the number of loads as control targets is large, the number of semiconductor devices and the like used for the energization control can be reduced.

The present invention is briefly described as above. Details of the present invention are further clarified by reading a mode for carrying out the present invention described below (hereinafter, referred to as “embodiment”) with reference to the accompanying drawings.

### BRIEF DESCRIPTION OF THE DRAWINGS

FIG. 1 is an electric circuit diagram showing a configuration example of an in-vehicle control system according to an embodiment of the present invention.

FIG. 2 is a flowchart showing a specific example of main control applied to the in-vehicle control system shown in FIG. 1.

FIG. 3 is a time chart showing an operation example of the in-vehicle control system shown in FIG. 1.

FIG. 4 is an electric circuit diagram showing a modification of the in-vehicle control system.

### DETAILED DESCRIPTION OF EMBODIMENTS

A specific embodiment according to the present invention will be described below with reference to the drawings.

(Configuration of in-Vehicle Control System)

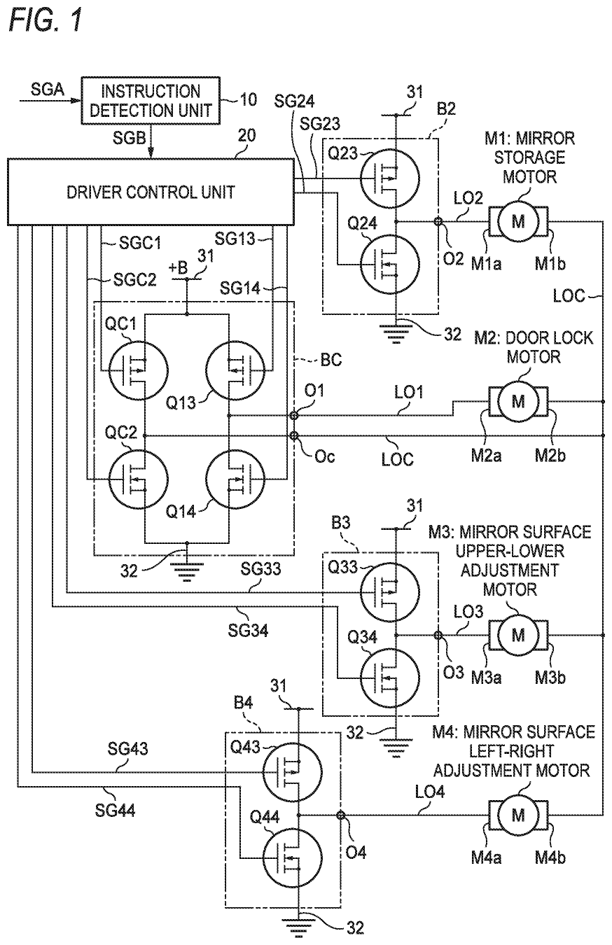

FIG. 1 is an electric circuit diagram showing a configuration example of an in-vehicle control system according to the embodiment of the present invention. The in-vehicle control system shown in FIG. 1 is assumed to be mounted on a vehicle as an electrical device that centrally controls a plurality of loads arranged in vicinity of a front door on the vehicle. Specifically, the electrical device controls electric motors M1, M2, M3 and M4 that drive mechanisms of four independent systems as loads.

The electric motor M1 is equipped in a mechanism that drives and positions a door mirror to a storage position (in a parking posture) and an expansion position (in a traveling posture). The electric motor M1 is rotated not only in a forward rotation direction but also in a reverse rotation direction in order to enable positioning drive to the storage position and the expansion position.

For example, when a terminal M1a is at a high potential and a terminal M1b is at a low potential, a current flows in an electric coil in the electric motor M1 in a forward direction, and the electric motor M1 is driven in the forward rotation direction. When the terminal Mia is at a low potential and the terminal M1b is at a high potential, a current flows in the electric coil in the electric motor M1 in a reverse direction, and the electric motor M1 is driven in the reverse rotation direction.

The electric motor M2 is equipped in a door lock mechanism in order to position the door lock mechanism at a locked position and an unlocked position. The electric motor M2 is rotated not only in the forward rotation direction but also in the reverse rotation direction in order to enable positioning drive to the locked position and the unlocked position. For example, when a terminal M2a is at a high potential and a terminal M2b is at a low potential, the electric motor M2 is driven in the forward rotation direction. When the terminal M2a is at a low potential and the terminal M2b is at a high potential, the electric motor M2 is driven in the reverse rotation direction.

The electric motor M3 is equipped in a mirror surface upper-lower adjustment mechanism that adjusts a mirror surface direction of the door mirror in an upper-lower direction. Since upward and downward adjustments are both required, the electric motor M3 is rotated not only in the forward rotation direction but also in the reverse rotation direction. For example, when a terminal M3a is at a high potential and a terminal M3b is at a low potential, the electric motor M3 is driven in the forward rotation direction. When the terminal M3a is at a low potential and the terminal M3b is at a high potential, the electric motor M3 is driven in the reverse rotation direction.

The electric motor M4 is equipped in a mirror surface left-right adjustment mechanism that adjusts the mirror surface direction of the door mirror in a left-right direction. Since leftward and rightward adjustments are both required, the electric motor M4 is rotated not only in the forward rotation direction but also in the reverse rotation direction. For example, when a terminal M4a is at a high potential and the terminal M4b is at a low potential, the electric motor M4 is driven in the forward rotation direction. When the terminal M4a is at a low potential and the terminal M4b is at a high potential, the electric motor M4 is driven in the reverse rotation direction.

Therefore, the electrical device that controls the four electric motors M1 to M4 is required to respectively control energization of the electric motors M1 to M4 in the forward direction and the reverse direction. Since the mechanisms to which the electric motors M1 to M4 are connected are independent from each other, individual control of ON and OFF and direction of energization is required on each mechanism.

In a configuration shown in FIG. 1, a single H-bridge circuit BC and three half-bridge circuits B2, B3 and B4 are provided as switches to control the energization of the four electric motors M1 to M4.

A structure of the H-bridge circuit BC is similar to that of a general H-bridge circuit. The H-bridge circuit BC includes four switching devices QC1, QC2, Q13 and Q14 connected to form an H-bridge. The switching devices QC1, Q13 on a high potential side are p-channel MOS type field effect transistors (FETs). The switching devices QC2, Q14 on a low potential side are n-channel MOS type FETs.

The switching devices QC1, QC2 form a series circuit. A high potential side (a drain terminal of the QC1) of the series circuit is connected to a power supply line 31, and a low potential side (a source terminal of the QC2) is connected to a ground line 32. The switching devices Q13 and Q14 form a series circuit. A high potential side (a drain terminal of the Q13) of the series circuit is connected to the power supply line 31, and a low potential side (a source terminal of the Q14) is connected to the ground line 32.

A connection portion between a source terminal of the switching device QC1 and a drain terminal of the switching device QC2 is connected to a common output terminal Oc of the H-bridge circuit BC. A connection portion between a source terminal of the switching device Q13 and a drain terminal of the switching device Q14 is connected to an output terminal O1 of the H-bridge circuit BC. Here, a plurality of loads can be commonly connected to the common output terminal Oc of the H-bridge circuit BC.

A configuration of each of the half-bridge circuits B2, B3 and B4 are similar to that of a general half-bridge circuit. The half-bridge circuit B2 includes two switching devices Q23, Q24 connected in series. The switching device Q23 on a high potential side is a p-channel MOS type FET, and the switching device Q24 on a low potential side is an n-channel MOS type FET. A drain terminal of the switching device Q23 is connected to the power supply line 31, and a source terminal of the switching device Q24 is connected to the ground line 32.

Similarly, the half-bridge circuit B3 includes switching devices Q33, Q34 connected in series, a drain terminal of the switching device Q33 is connected to the power supply line 31, and a source terminal of the switching device Q34 is connected to the ground line 32. In addition, the half-bridge circuit B4 includes switching devices Q43 and Q44 connected in series, a drain terminal of the switching device Q43 is connected to the power supply line 31, and a source terminal of the switching device Q44 is connected to the ground line 32.

One terminal Mia of the electric motor M1 is connected to an output terminal O2 of the half-bridge circuit B2 via an individual output line LO2, and the other terminal M1b is connected to the common output terminal Oc of the H-bridge circuit BC via a common output line LOC.

One terminal M2a of the electric motor M2 is connected to the output terminal O1 of the H-bridge circuit BC via an individual output line LO1, and the other terminal M2b is connected to the common output terminal Oc of the H-bridge circuit BC via the common output line LOC.

One terminal M3a of the electric motor M3 is connected to an output terminal O3 of the half-bridge circuit B3 via an individual output line LO3, and the other terminal M3b is connected to the common output terminal Oc of the H-bridge circuit BC via the common output line LOC. Similarly, one terminal M4a of the electric motor M4 is connected to an output terminal O4 of the half-bridge circuit B4 via an individual output line LO4, and the other terminal M4b is connected to the common output terminal Oc of the H-bridge circuit BC via the common output line LOC.

That is, each of the four electric motors M1 to M4 as the loads, is connected in a state in which the common output terminal Oc of the single H-bridge circuit BC is shared. Thereby, switching of the ON and OFF and the energization direction of each of the electric motors M1 to M4 can be controlled without increasing the number of the H-bridge circuits BC. That is, since the number of switching devices built in each of the half-bridge circuits B2 to B4 are only two, and are half of that of the H-bridge circuit BC, the number of components of the entire system can be reduced.

Here, since the four electric motors M1 to M4 as the loads share the single common output terminal Oc, there is a restriction that only one of the four electric motors M1 to M4 can be driven at any timing. Due to this restriction, exclusive control is performed. That is, if any one of the four electric motors M1 to M4 is already driven (ON), the other electric motors are controlled so as not to be driven (turned OFF).

The in-vehicle control system shown in FIG. 1 includes an instruction detection unit 10 and a driver control unit 20 in addition to the above-described components. The instruction detection unit 10 inputs various instructions generated for each mechanism as a signal SGA along with a switch operation or the like by a user, and outputs a signal SGB to control the driver control unit 20.

The driver control unit 20 generates control signals SGC1, SGC2, SG13, SG14, SG23, SG24, SG33, SG34, SG43 and SG44 according to the signal SGB input from the instruction detection unit 10.

For example, when the electric motor M1 is driven in the forward rotation direction, the driver control unit 20 controls the control signals as follows.

SGC1: OFF level (non-conductive between drain and source of QC1)

SGC2: ON level (conductive between drain and source of QC2)

SG13: OFF level (non-conductive between drain and source of Q13)

SG14: OFF level (non-conductive between drain and source of Q14)

SG23: ON level (conductive between drain and source of Q23)

SG24: OFF level (non-conductive between drain and source of Q24)

SG33: OFF level (non-conductive between drain and source of Q33)

SG34: OFF level (non-conductive between drain and source of Q34)

SG43: OFF level (non-conductive between drain and source of Q43)

SG44: OFF level (non-conductive between drain and source of Q44)

In the above state, a current flows from the power supply line 31 to the ground line 32, through the switching device Q23 in the half-bridge circuit B2, through the output terminal O2, the individual output line LO2, the terminal Mia, the electric motor M1, the terminal M1b, the common output line LOC and the common output terminal Oc, and through the switching device QC2 in the H-bridge circuit BC. Therefore, the current flows in the electric coil in the electric motor M1 in the forward direction, and the electric motor M1 is driven to rotate forward.

On the other hand, when the electric motor M1 is driven in the reverse rotation direction, the driver control unit 20 controls the control signals as follows.

SGC1: ON level (conductive between drain and source of QC1)

SGC2: OFF level (non-conductive between drain and source of QC2)

SG13: OFF level (non-conductive between drain and source of Q13)

SG14: OFF level (non-conductive between drain and source of Q14)

SG23: OFF level (non-conductive between drain and source of Q23)

SG24: ON level (conductive between drain and source of Q24)

SG33: OFF level (non-conductive between drain and source of Q33)

SG34: OFF level (non-conductive between drain and source of Q34)

SG43: OFF level (non-conductive between drain and source of Q43)

SG44: OFF level (non-conductive between drain and source of Q44)

In the above state, a current flows from the power supply line 31 to the ground line 32, through the switching device QC1 in the H-bridge circuit BC, through the common output terminal Oc, the common output line LOC, the terminal M1b, the electric motor M1, the terminal Mia, the individual output line LO2 and the output terminal O2, and through the switching device Q24 in the half-bridge circuit B2. Therefore, the current flows in the electric coil in the electric motor M1 in the reverse direction, and the electric motor M1 is driven to rotate reversely.

For each of the electric motors M2, M3 and M4 other than the electric motor M1, the ON and OFF and a drive direction can be controlled by switching the control signals SGC1, SGC2, SG13, SG14, SG23, SG24, SG33, SG34, SG43, SG44. Due to necessity of the exclusive control, the instruction detection unit 10 or the driver control unit 20 cannot simultaneously drive the plurality of electric motors M1 to M4.

(Specific Example of Main Control)

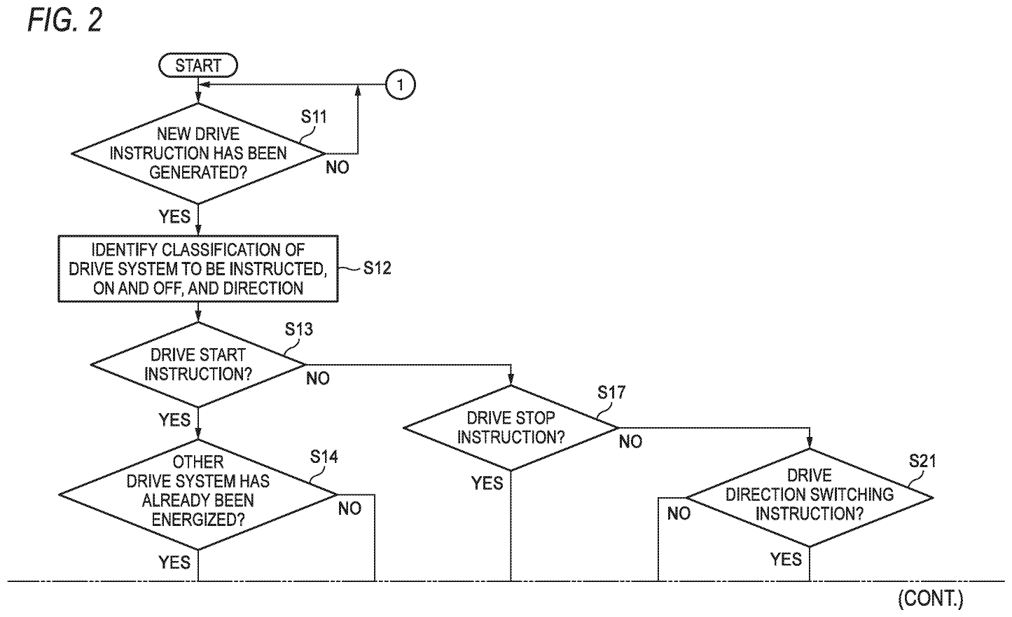

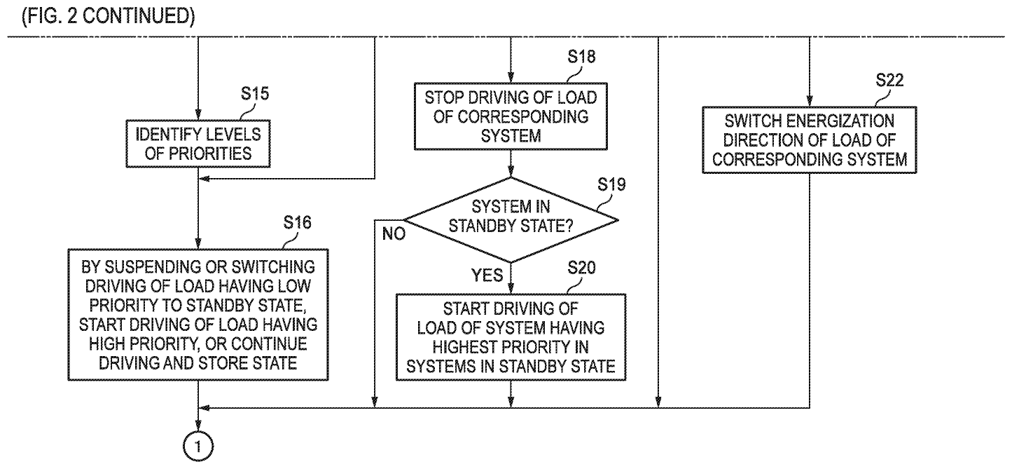

FIG. 2 is a flowchart showing a specific example of main control applied to the in-vehicle control system shown in FIG. 1. For example, the instruction detection unit 10 or the driver control unit 20 in FIG. 1 performs the control shown in FIG. 2. The control shown in FIG. 2 is assumed to be realized, for example, by executing a predetermined program with a microcomputer, or by dedicated hardware using an appropriate logic circuit.

The control shown in FIG. 2 includes processing for exclusive control on the four electric motors M1 to M4 as the loads, and processing for appropriate control on the electric motors M1 to M4 by managing priorities thereof.

In the present embodiment, the priorities are assigned in advance as follows.

Priority 1 (top): electric motor M2 (door lock and unlock control)

Priority 2: electric motor M1 (door mirror storage and expansion control)

Priority 3: electric motors M3, M4 (mirror surface direction upper-lower and left-right adjustment)

For example, the signal SGA is input to the instruction detection unit 10 via a communication network on the vehicle. The instruction detection unit 10 constantly monitors an input situation of the signal SGA and identifies whether a new drive instruction has been generated in S11.

The signal SGA input to the instruction detection unit 10 includes classification of the electric motors M1 to M4 as drive targets, an ON and OFF instruction, a drive direction instruction and the like.

When detecting generation of the new drive instruction in S11, the instruction detection unit 10 identifies contents of the signal SGA (S12). That is, classification of the instructed electric motors M1 to M4 as the drive targets, classification of the ON (drive start) and OFF (drive stop), and classification of the drive direction (forward rotation and reverse rotation) are identified.

Next, the instruction detection unit 10 identifies whether the new instruction detected in S11 is a drive start instruction (S13). When the drive start instruction is detected, the processing proceeds from S13 to S14. When any other instruction is detected, the processing proceeds to S17.

When the drive start instruction is detected, the instruction detection unit 10 identifies whether an electric motor other than the drive target instructed this time has already been energized (S14). If the electric motor other than the drive target has already been energized, the processing proceeds to S15, and if the electric motor is not energized, the processing proceeds to S16.

The instruction detection unit 10 identifies levels of priorities for an electric motor Mx currently being energized and an electric motor My as the drive target instructed this time (S15).

For example, if all the electric motors M1 to M4 are in a non-energized state, the instruction detection unit 10 starts energizing the electric motor My as the drive target in S16 according to the instruction. When the electric motor Mx already energized exists and the priority of the electric motor Mx is lower than that of the electric motor My, energization of the electric motor My as the drive target is started in S16 after driving of the electric motor Mx having the low priority is suspended or switched to a standby state (non-energization). When the electric motor Mx already energized exists and the priority of the electric motor Mx is higher than that of the electric motor My, the instruction detection unit 10 continues to drive the electric motor Mx having the high priority in S16, and stores that the electric motor My is in the drive standby state.

For example, when the electric motor M1 is driven in the forward rotation direction, the instruction detection unit 10 outputs the signal SGB to control the driver control unit 20 such that the control signals SGC1, SGC2, SG13, SG14, SG23, SG24, SG33, SG34, SG43, SG44 output from the driver control unit 20 are determined in the following states.

SGC1: OFF level, SGC2: ON level, SG13: OFF level, SG14: OFF level, SG23: ON level, SG24: OFF level, SG33: OFF level, SG34: OFF level, SG43: OFF level, SG44: OFF level.

On the other hand, when a “drive stop instruction” is detected, the processing proceeds from S17 to S18, and the instruction detection unit 10 stops the energization of the electric motor My instructed this time.

The instruction detection unit 10 identifies presence or absence of a standby electric motor Mz waiting for a start of the energization in S19, and the processing proceeds to S20 when the standby electric motor Mz is present.

The instruction detection unit 10 starts or resumes driving the standby electric motor Mz in S20. When a plurality of standby electric motors Mz are present, driving of only one electric motor Mz having the highest priority among the plurality of standby electric motors Mz is started or resumed in S20.

On the other hand, when a “drive direction switching instruction” is detected, the processing proceeds from S21 to S22, and the instruction detection unit 10 switches an energization direction of the electric motor My instructed this time to an opposite direction.

(Description of Operation Example)

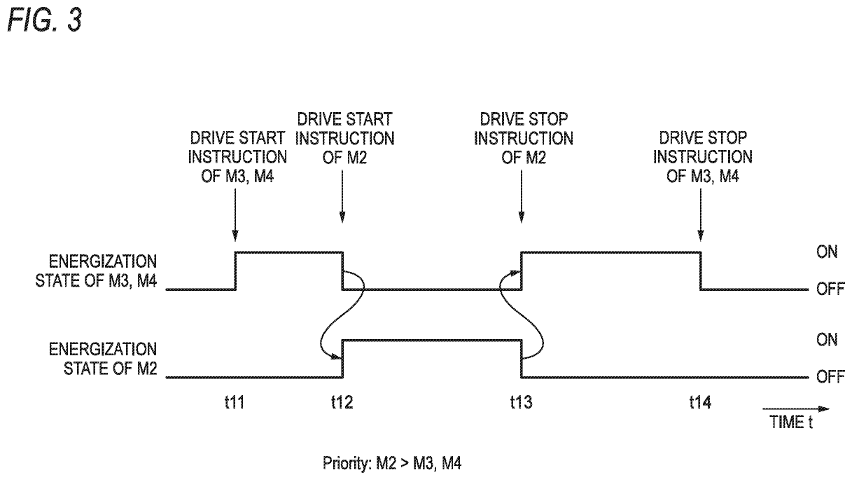

FIG. 3 is a time chart showing an operation example of the in-vehicle control system shown in FIG. 1. In the operation example shown in FIG. 3 as well, the electric motor M2 is assumed to have a priority higher than that of the electric motors M3, M4 similarly to the above example.

In the example shown in FIG. 3, the following situations (1) to (4) are assumed.

(1) At time t11, a drive start instruction for the electric motor M3 or M4 is generated.

(2) At time t12, a drive start instruction for the electric motor M2 is generated.

(3) At time t13, a drive stop instruction for the electric motor M2 is generated.

(4) At time t14, a drive stop instruction for the electric motor M3 or M4 is generated.

In this situation, the in-vehicle control system operates as follows.

(Operation at the time t11): According to the instruction generated at the time t11, the instruction detection unit 10 starts energizing the electric motor M3 or M4.

(Operation at the time t12): Since the electric motor M2 has the priority higher than that of the electric motors M3, M4, after stopping energizing the electric motor M3 or M4 having the low priority, the instruction detection unit 10 starts energizing the electric motor M2 having the high priority according to the instruction generated at the time t12.

(Operation at the time t13): According to the instruction generated at the time t13, after stopping energizing the electric motor M2, the instruction detection unit 10 resumes energizing the electric motor M3 or M4 in a standby state.

(Operation at the time t14): According to the instruction generated at the time t14, the instruction detection unit 10 stops energizing the electric motor M3 or M4.

That is, the instruction detection unit 10 performs exclusive control such that the plurality of electric motors M1 to M4 is not simultaneously driven. Therefore, even if the plurality of electric motors shares the common output terminal Oc of the single H-bridge circuit BC, malfunction does not occur. As in the operation at the time t12 in the example shown in FIG. 3, even if the other electric motor M3 or M4 is already energized, energization of the electric motor M2 can be started without delay when the drive start instruction for the electric motor M2 having the high priority is generated. As in the operation at the time t13 in the example shown in FIG. 3, when the energization of the electric motor M2 having the high priority is completed, energization of the electric motor M3 or M4 in the standby state can be automatically resumed.

(Modification)

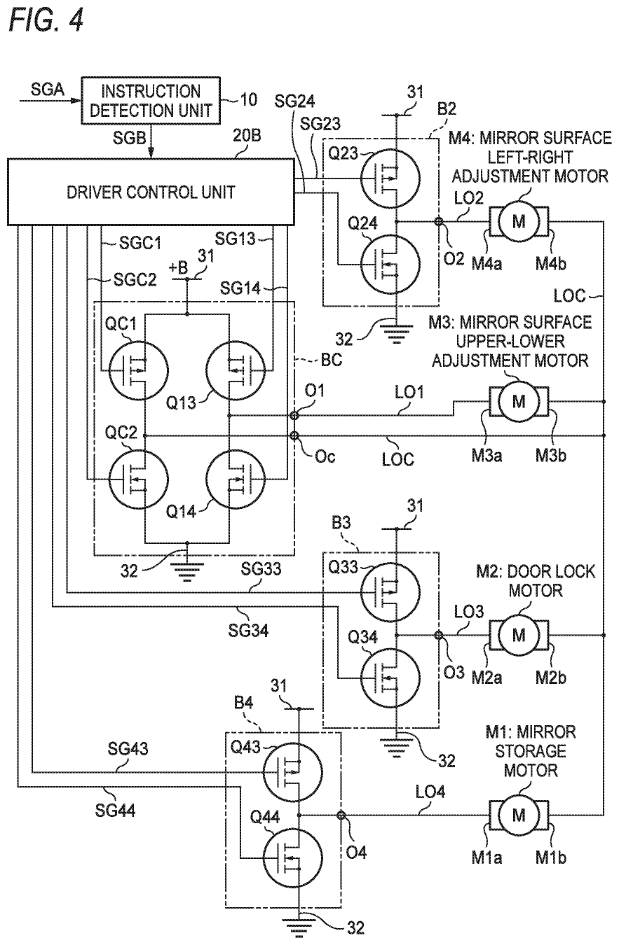

FIG. 4 is an electric circuit diagram showing a modification of the in-vehicle control system. In the in-vehicle control system shown in FIG. 4, the electric motor M4 for mirror surface left-right adjustment, the electric motor M3 for mirror surface upper-lower adjustment, the electric motor M2 for door lock and the electric motor M1 for mirror storage are respectively connected to output terminals O2, O1, O3 and O4. Since connection positions of the electric motors M1 to M4 are different, operation of the driver control unit 20B is changed. Others are similar to those of the in-vehicle control system shown in FIG. 1.

The number of the electric motors M1 to M4 connected to the in-vehicle control system as the loads can be increased or decreased as necessary. For example, if one half-bridge circuit is added, the number of the electric motors to be connected can be increased by one. A load other than the electric motor may be connected to output of the in-vehicle control system shown in FIGS. 1 and 4. The instruction detection unit 10 and the driver control unit 20 may also be integrated. The switching devices constituting the H-bridge circuit BC and the half-bridge circuits B2 to B4 are not limited to a MOSFET, and a general transistor or a mechanical switch such as a relay can be adopted.

When energization of the four electric motors M1 to M4 is controlled in both directions, four H-bridge circuits are generally required, so that the number of the switching devices required is (4×4=16). However, since the number of the switching devices required in configurations shown in FIGS. 1 and 4 is reduced to ten, component cost can be reduced or the like.

Although the specific embodiment has been described above, aspects of the present invention are not limited to the embodiment, and may be appropriately modified, improved or the like.

Characteristic matters related to the load control device, the load control system and the in-vehicle control system described above are briefly summarized and listed in the following [1] to [5].

[1] A load control device configured to control three or more independent loads (electric motors M1 to M4) that can be driven reversibly by switching an energization direction and that allow an alternative operation.

The load control device includes:

one H-bridge circuit (BC);

a plurality of half-bridge circuits (B2 to B4);

a common connection circuit (common output line LOC) that connects one terminal (M1b, M2b, M3b, M4b) of each of the plurality of loads commonly to one output terminal (common output terminal Oc) of the H-bridge circuit;

individual connection circuits (individual output lines LO1 to LO4), each of which connects the other terminal (Mia, M2a, M3a, M4a) of each of the plurality of loads to the other output terminal (O1) of the H-bridge circuit or any one of the output terminals (O2 to O4) of the plurality of half-bridge circuits; and

an exclusive control unit (instruction detection unit 10, S14, S16) that generates signals to be respectively supplied to the H-bridge circuit and the plurality of half-bridge circuits to exclusively control the plurality of loads.

[2] In the load control device according to [1],

when an input of a simultaneous drive instruction for each of the plurality of loads is detected, the exclusive control unit drives only the load having a highest priority among the plurality of loads for which the drive instruction has been generated, according to priorities assigned to the plurality of loads (S14 to S16, S20).

[3] A load control system includes:

three or more independent loads (electric motors M1 to M4) that can be reversibly driven by switching an energization direction and that allow an alternative operation;

one H-bridge circuit (BC);

a plurality of half-bridge circuits (B2 to B4);

a common connection circuit (common output line LOC) that connects one terminal of each of the plurality of loads commonly to one output terminal of the H-bridge circuit;

individual connection circuits (individual output lines LO1 to LO4), each of which connects the other terminal of each of the plurality of loads to the other output terminal of the H-bridge circuit or any one of the output terminals of the plurality of half-bridge circuits;

an exclusive control unit (instruction detection unit 10, S14, S16) that generates signals to be respectively supplied to the H-bridge circuit and the plurality of half-bridge circuits to exclusively control the plurality of loads; and

a drive instruction generation unit (instruction detection unit 10, S11 to S13) that supplies a drive instruction for each of the plurality of loads to the exclusive control unit.

[4] In the load control system according to [3],

when the drive instruction for each of the plurality of loads is input from the drive instruction generation unit, the exclusive control unit drives only the load having a highest priority among the plurality of loads for which the drive instruction has been generated, according to priorities assigned to the plurality of loads (S14 to S16).

[5] An in-vehicle control system includes:

three or more independent loads (electric motors M1 to M4) that are mounted on a vehicle and can be driven reversibly by switching an energization direction and that allow an alternative operation;

one H-bridge circuit (BC);

a plurality of half-bridge circuits (B2 to B4);

a common connection circuit (common output line LOC) that connects one terminal of each of the plurality of loads commonly to one output terminal of the H-bridge circuit;

individual connection circuits (individual output lines LO1 to LO4), each of which connects the other terminal of each of the plurality of loads to the other output terminal of the H-bridge circuit or any one of the output terminals of the plurality of half-bridge circuits;

an exclusive control unit (instruction detection unit 10, S14, S16) that generates signals to be respectively supplied to the H-bridge circuit and the plurality of half-bridge circuits to exclusively control the plurality of loads; and

a drive instruction generation unit (instruction detection unit 10, S11 to S13) that supplies a drive instruction for each of the plurality of loads to the exclusive control unit.

What is claimed is:

1. A load control device configured to control three or more independent loads that can be driven reversibly by switching an energization direction and that allow an alternative operation, the load control device comprising:
one H-bridge circuit;
a plurality of half-bridge circuits;
a common connection circuit that connects one terminal of each of the plurality of loads commonly to one output terminal of the H-bridge circuit;
individual connection circuits, each of which connects the other terminal of each of the plurality of loads to the other output terminal of the H-bridge circuit or any one of the output terminals of the plurality of half-bridge circuits; and
an exclusive control unit that generates signals to be respectively supplied to the H-bridge circuit and the plurality of half-bridge circuits to exclusively control the plurality of loads.

2. The load control device according to claim 1,
wherein, when an input of a simultaneous drive instruction for each of the plurality of loads is detected, the exclusive control unit drives only the load having a highest priority among the plurality of loads for which the drive instruction has been generated, according to priorities assigned to the plurality of loads.

3. A load control system comprising:
three or more independent loads that can be reversibly driven by switching an energization direction and that allow an alternative operation:
one H-bridge circuit;
a plurality of half-bridge circuits;
a common connection circuit that connects one terminal of each of the plurality of loads commonly to one output terminal of the H-bridge circuit;
individual connection circuits, each of which connects the other terminal of each of the plurality of loads to the other output terminal of the H-bridge circuit or any one of the output terminals of the plurality of half-bridge circuits;
an exclusive control unit that generates signals to be respectively supplied to the H-bridge circuit and the plurality of half-bridge circuits to exclusively control the plurality of loads; and
a drive instruction generation unit that supplies a drive instruction for each of the plurality of loads to the exclusive control unit.

4. The load control system according to claim 3,
wherein, when the drive instruction for each of the plurality of loads is input from the drive instruction generation unit, the exclusive control unit drives only the load having a highest priority among the plurality of loads for which the drive instruction has been generated, according to priorities assigned to the plurality of loads.

5. An in-vehicle control system comprising:
three or more independent loads that are mounted on a vehicle and can be driven reversibly by switching an energization direction and that allow an alternative operation;
one H-bridge circuit;
a plurality of half-bridge circuits;
a common connection circuit that connects one terminal of each of the plurality of loads commonly to one output terminal of the H-bridge circuit;
individual connection circuits, each of which connects the other terminal of each of the plurality of loads to the other output terminal of the H-bridge circuit or any one of the output terminals of the plurality of half-bridge circuits;
an exclusive control unit that generates signals to be respectively supplied to the H-bridge circuit and the plurality of half-bridge circuits to exclusively control the plurality of loads; and
a drive instruction generation unit that supplies a drive instruction for each of the plurality of loads to the exclusive control unit.
